(19) United States
(12) Patent Application Publication
(10) Pub. No.: US 2009/0126512 A1
(43) Pub. Date: May 21, 2009

(54) METHOD FOR SENSING APPLIED FORCE FOR CONTROLLING THE MATERIAL REMOVAL RATE FOR A FLAT FINE MACHINED SURFACE

(75) Inventors: Michael A. Betz, Huxley, IA (US); Eric D. Bretey, Rowan, IA (US)

Correspondence Address: ZARLEY LAW FIRM P.L.C., CAPITAL SQUARE, 400 LOCUST, SUITE 200, DES MOINES, IA, 50309-2350, US

(73) Assignee: SAUER-DANFOSS INC., Ames, IA (US)

(21) Appl. No.: 11/943,358

(22) Filed: Nov. 20, 2007

(51) Int. Cl. G01L 5/00

(52) U.S. Cl. 73/862.381

(57) ABSTRACT

A method of adjusting the applied force for controlling the material removal rate on a work piece. A machining device having a load providing device, a force transducer and a force applying device wherein the force-applying device provides a load to the work piece to remove material. The force applied to the work piece by the load providing device and the position of the load providing device are sensed and transmitted to a master controller that adjusts the force applied to the work piece based upon these readings.

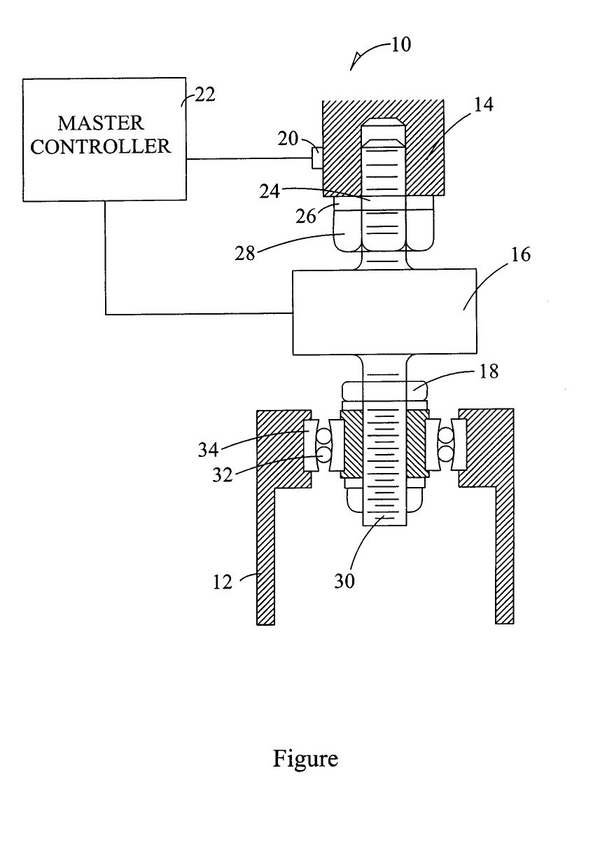

### BACKGROUND OF THE INVENTION

This invention relates to a method of removing material from a surface. More specifically this invention relates to a method of sensing applied force to control the material removal rate from a machined surface.

When manufacturing products oftentimes to provide desired surfaces a removing device that contains an abrasive surface thereon is used to properly machine components. Specifically for typical application of a flat honing process (a method of material removal on a surface, usual flat or near flat, from a work piece by a rotating hard flexible abrasive surface) the material removal rate is a function of the age of the fixed abrasive and force applied to the work piece as well as other relative surface displacements.

The differences in material removal rates affects important tribological surface characteristics such as topography or finish, and surface form, or flatness, as well as dimensional size characteristics. The material removal rate for the current state of the art shows typical removal rate decreasing at an exponential rate for constant cycle time lengths and fixed application forces. This characteristic includes a variation in the surface topography and surface form as well as dimensional size characteristics of the part being flat honed.

The current state of the art is limited in its ability to reduce variation as well as providing a feedback to a control system to adjust applied force to a work piece thereby reducing the material rate and ultimately the total amount of material removed. Thus there is a need to provide an improved method in order to optimize both surface topography and form while still minimizing manufacturing costs.

Thus a principal object of the present invention is to provide an improved method of machining a flat work surface.

Yet another object of the present invention is to use closed loop feedback in order to alter the machining process.

Yet another object of the present invention is to reduce overall manufacturing costs by providing an improved method of machining.

These and other objects, features or advantages of the present invention will become apparent from the specification and claims.

### BRIEF SUMMARY OF THE INVENTION

A method of adjusting the applied force for controlling the material removal rate on a work piece. The method includes sensing the force applied to the work piece by a load providing device and also sensing the position of the load providing device. Next the sensed force applied and sensed position of the load providing device is transmitted to a master controller such that the master controller adjusts the force applied to the work piece based upon the data to produce a target work surface characteristic.

### DETAILED DESCRIPTION OF THE DRAWINGS

The FIGURE is a side sectional view of a device used machine a work surface.

### DETAILED DESCRIPTION OF THE PREFERRED EMBODIMENT

The FIGURE shows a machining device 10 used in order to remove the surface 11 of a work piece 12. The machining device 10 has three major components, a load providing device 14, a force transducer 16 and a force applying device 18 that are all interconnected.

The load providing device 14 in one embodiment is a load cylinder such as an air cylinder or optionally could also be a ball screw actuator or the like. The load providing device 14 additionally has a sensor 20 associated therewith that is used to measure the linear position of the load providing device 14. In a preferred embodiment the sensor 20 is a linear variable differential transformer (LVDT) that is electrically connected to a master controller 22 in order to send a constant signal to the master controller 22 regarding the position of the load providing device 14.

The force transducer 16 is considered a load cell and has an attachment member 24 that extends therefrom for attachment with the load providing device 14. In the embodiment as shown in the FIGURE the attachment device 24 may be a threaded shaft that is disposed through the load providing device 14 and secured therein by a washer element 26 and nut element 28. The load providing device 14 is not rotatable relative to the force transducer 16. Thus the force transducer 16 by being connected to the master controller 22 allows the master controller to collect data such as force applied and position of the load providing device 14.

Extending from the force transducer 16 is a second attachment member 30 that rotatably connects the force transducer 16 to the force applying device 18 through anti-friction bearings 32. The anti-friction bearings 32 allow relative rotation between the force providing device 14 and the force applying device 18 connected to the work piece 12. The work piece 12 then engages an abrasive material 34 used to machine the work piece 12.

In operation the force applying device 18 rotates relative to the force transducer 16 and load providing device 14 and acts upon the work piece 12. The surface 11 of work piece 12 is thus machined with the abrasive material 34. As the surface 11 of work piece 12 is machined the force transducer 16 communicates with the master controller 22 to sense force applied to the work piece 12 by the load providing device 14 while the sensor 20 senses the position of the load providing device 14. The sensed forces are then transmitted to the master controller 22 such that the master controller 22 adjusts the force applied to the work piece 12 based upon this information. As a result measurement of current or voltage controls the pressure supplied to the load providing device 14.

By controlling the force provided by the force providing device 14 with the master controller 22 improved more effective removal of material is provided. Not only does this machining process provide for a better surface topography and form in dimensional size but additionally costs are reduced in the manufacturing process. Thus at the very least all of the stated objectives have been met.

It will be appreciated by those skilled in the art that other various modifications could be made to the device without the parting from the spirit in scope of this invention. All such modifications and changes fall within the scope of the claims and are intended to be covered thereby.

1. A method of adjusting the applied force for controlling the material removal rate on a work piece, comprising the steps of:
sensing the force applied to the work piece by a load providing device;
sensing the position of the load providing device;
transmitting the sensed force applied and the sensed position of the load providing device to a master controller; and
adjusting the force applied to the work piece based upon the sensed force applied and the sensed position of the load providing device with the master controller.

2. The method of claim 1 wherein the load providing device is a load cylinder.

3. The method of claim 1 wherein the load providing device has a linear variable differential transformer that senses the position of the load providing device.

4. The method of claim 1 wherein a force transducer is rotatably connected between the load providing device and a force applying device that applies the force to the work piece.

5. The method of claim 4 wherein the force transducer is a load cell.

6. The method of claim 4 wherein a force applying device is rotatably connected to the force transducer.

7. The method of claim 3 wherein the linear variable differential transformer is electrically connected and in communication with a master controller.
